(19) United States
(12) Patent Application Publication
(10) Pub. No.: US 2003/0002015 A1
(43) Pub. Date: Jan. 2, 2003

(54) Back projection display apparatus

(76) Inventor: Nicholas Richard Coates, Crowborough (GB)

Correspondence Address: Iandiorio & Teska, 260 Bear Hill Road, Waltham, MA, 02451-1018, US

(21) Appl. No.: 10/182,347

(22) PCT Filed: Dec. 7, 2001
(86) PCT No.: PCT/GB01/05440

(30) Foreign Application Priority Data
Dec. 18, 2000 (GB) 00308619

(51) Int. Cl. G03B 21/14

(52) U.S. Cl. 353/20

(57) ABSTRACT

Display apparatus (2) for displaying an image by back projection, which display apparatus (2) comprises a projector (4), a screen (6), and a quarterwave retarder (8), the screen (6) being a back projection screen (6) that maintains the polarisation state of incident light (10), the quarterwave retarder (8) being orientated such that its axis at 45° to the axis of polarised light (11) from the projector (4), and the quarterwave retarder (8) being such that it circularly polarizes linearly polarized light that it receives, for example from the projector (4) .

This invention relates to display apparatus for displaying an image by back projection.

There is currently much interest in the use of back projection in display devices which are used in applications such for example as arcade games, large television screens and large monitor screens. There is even currently much interest in the use of back projection in display devices as a replacement for cathode ray tube monitors and liquid crystal display monitors in desktop computer displays. Display devices utilise a projector and a screen and in many cases, the projector and the screen are built into a unit, often using mirrors to fold the path of the light. Projected images are best viewed in a darkened room because ambient light reflecting from the screen reduces the contrast of the image. However, for many of the above mentioned applications, darkness is undesirable.

Many display devices using back projection have the following two problems. The first problem is that the back projection screens work by scattering the light projected from behind mostly in the forward direction, thus forming an image. Usually, this scattering process destroys the polarisation of the light and renders it randomly polarised. The second problem is that ambient light which is incident from the front of the screen is mostly transmitted through the screen where it can be absorbed by black surfaces. Some ambient light scatters forward and it is this light which is detrimental to the contrast.

There are some types of known screen material which maintain the polarisation state of the incident light, thereby overcoming the above mentioned first problem. We have now been found that those types of screen which preserve the polarisation of back projected light, will also preserve the polarisation of ambient light incident from the front. The reflection of this light can be suppressed by means of a circular polariser, thereby overcoming the above mentioned second problem.

Thus, in accordance with one non-limiting embodiment of the present invention, there is provided display apparatus for displaying an image by back projection, which display apparatus comprises a projector, a screen, and a quarterwave retarder, the screen being a back projection screen that maintains the polarisation state of incident light, the quarterwave retarder being orientated such that its axis is at 45° to the axis of polarised light from the projector, and the quarterwave retarder being such that it circularly polarises linearly polarised light that it receives.

The display apparatus of the present invention is able to provide improved contrast of an image displayed on a screen in bright ambient light.

The quarterwave retarder is preferably a polymer sheet quarterwave retarder. Other types of quarterwave retarder may however be employed.

The quarterwave retarder may be positioned in front of a projector lens from the projector. Alternatively, the quarterwave retarder may be built into the projector.

The display apparatus may include polariser means which is positioned such that the screen lies between the projector and the polariser means.

The polariser means may be laminated to the screen. Preferably, the polariser means is laminated to the screen so as to form a single sheet.

The polariser means may be a quarterwave retarder and a circular polariser, the orientation of the quarterwave retarder relative to the circular polariser being such that the polariser means transmits the polarised light that it receives. Preferably, the linear polarising component of the circular polariser is oriented parallel to the linear polarisation axis of the projector.

Preferably, the display apparatus is one in which the projector is such that it provides the linearly polarised light. In an alternative embodiment of the invention, the display apparatus may be one in which the projector is such that it provides unpolarised light, and in which the display apparatus includes a polariser which is positioned between the projector and the quarterwave retarder and which is for providing the linearly polarised light. This would halve the light output from the projector and is thus a less preferred embodiment of the invention.

An embodiment of the invention will now be described solely by way of example and with reference to the accompanying drawings in which:

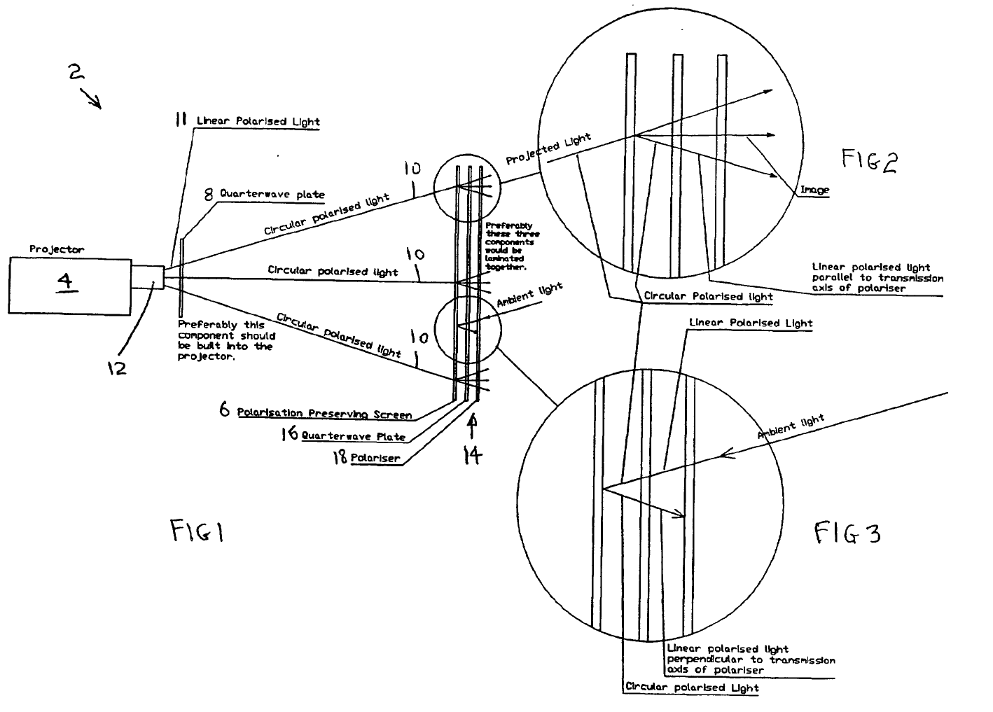

FIG. 1 shows display apparatus for displaying an image by back projection;

FIG. 2 is an enlarged part of a portion of FIG. 1; and

FIG. 3 is an enlarged part of another portion of FIG. 1.

Referring to the drawings, there is shown display apparatus 2 for displaying an image by back projection. The display apparatus 2 comprises a projector 4, a screen 6 and a quarterwave retarder 8. The screen 6 is a back projection screen 6 that maintains the polarisation state of incident light 10. The quarterwave retarder 8 is orientated such that its axis is at 45° to the axis of polarised light 11 from the projector 4.

The light 11 from the projector 4 is linearly polarised light. The quarterwave retarder 8 is in the form of a quarterwave retarder plate. The quarterwave retarder 8 circularly polarises the linear polarised light from the projector 4.

The quarterwave retarder 8 is a polymer sheet quarterwave retarder 8.

As can be seen from FIG. 1, the quarterwave retarder 8 is positioned in front of a projector lens part 12 of the projector 4.

The display apparatus includes polariser means 14 which is positioned such that the screen lies between the projector and the polariser means. More specifically, the polariser means 14 is laminated to the screen 6 to form a single sheet. The polariser means 14 comprises a quarterwave retarder 16 and a polariser 18. The orientation of the quarterwave retarder 16 relative to the polariser 18 is such that the polariser means 14 transmits the polarised light that it receives. The linear polarising component of the circular polariser 18 is orientated parallel to the linear polarisation axis of the projector 4.

The various light paths and the type of polarised light are shown in FIG. 1. FIG. 2 shows part of FIG. 1 involving projected light, and FIG. 3 shows part of FIG. 1 involving ambient light.

The display apparatus 2 operates such that light from the projector 4 is able to pass through the screen 6 and the circular polariser 18. Thus the light from the projector 4 can be viewed as normal. Ambient light however will become circularly polarised before it falls on to the screen 6. Because the screen 6 mostly maintains that polarisation on the light, which is reflected forwards, this light will be unable to pass back through the circular polariser 18. This light is thus unable to interfere with the image, and the contrast is improved. This is especially advantageous in bright ambient light where, hitherto, the contrast has often been insufficient.

It is to be appreciated that the embodiment of the invention described above with reference to the accompanying drawings has been given by way of example only and that modifications may be effected. Thus, for example, the quarterwave retarder 8 may be built into the projector 4 instead of being positioned in front of the projector lens part 12 of the projector 4. The projector 4 could be such that it provides an unpolarised output, which is then polarised by a polariser positioned between the projector 4 and the quarterwave retarder 8.

1. Display apparatus for displaying an image by back projection, which display apparatus comprises a projector, a screen, and a quarterwave retarder, the screen being a back projection screen that maintains the polarisation state of incident light, the quarterwave retarder being orientated such that its axis is at 45° to the axis of polarised light from the projector, and the quarterwave retarder being such that it circularly polarises linearly polarised light that it receives.

2. Display apparatus according to claim 1 in which the quarterwave retarder is a polymer sheet quarterwave retarder.

3. Display apparatus according to claim 1 or claim 2 in which the quarterwave retarder is positioned in front of a projector lens of the projector.

4. Display apparatus according to claim 1 or claim 2 in which the quarterwave retarder is built into the projector.

5. Display apparatus according to any one of the preceding claims and including polariser means which is positioned such that the screen lies between the projector and the polariser means.

6. Display apparatus according to claim 5 in which the polariser means is laminated to the screen.

7. Display apparatus according to claim 6 in which the polariser means is laminated to the screen so as to form a single sheet.

8. Display apparatus according to any one of the preceding claims in which the polariser means is a quarterwave retarder and a circular polariser, the orientation of the quarterwave retarder relative to the circular polariser being such that the polariser means transmits the polarised light that it receives.

9. Display apparatus according to claim 8 in which the linear polarising component of the circular polariser is oriented parallel to the linear polarisation axis of the projector.

10. Display apparatus according to any one of the preceding claims in which the projector is such that it provides the linearly polarised light.

11. Display apparatus according to any one of claims 1-9 in which the projector is such that it provides unpolarised light, and in which the display apparatus includes a polariser which is positioned between the projector and the quarterwave retarder and which is for providing the linearly polarised light.
